(19) United States
(12) Patent Application Publication
(10) Pub. No.: US 2026/0331948 A1
(43) Pub. Date: Oct. 22, 2026

(54) ENERGY HARVESTER-BASED SWITCH

(71) Applicant: Kwangwoon University Industry-Academic Collaboration Foundation, Seoul (KR)

(72) Inventors: Jae Yeong PARK, Seoul (KR); Trilochan BHATTA, Seoul (KR)

(73) Assignee: Kwangwoon University Industry-Academic Collaboration Foundation, Seoul (KR)

(21) Appl. No.: 19/653,742

(22) Filed: Apr. 21, 2026

(30) Foreign Application Priority Data
Apr. 22, 2025 (KR) 10-2025-0052393

(51) Int. Cl. H02J 50/00; H02J 13/13; H02J 13/34

(52) U.S. Cl. CPC H02J 50/001; H02J 13/1331; H02J 13/34; H02J 50/005

(57) ABSTRACT

Provided is an energy harvester-based switch. The energy harvester-based switch includes: a coil in which a voltage is induced by electromagnetic induction, a magnetic core magnetically coupled to the coil and having a magnetic core cross-section, and a magnet magnetically coupled to the magnetic core, slidable along the magnetic core cross-section by an external force and configured to induce a voltage in the coil via electromagnetic induction with the magnetic core through the sliding movement without requiring a physical closed circuit loop for flux flow.

### CROSS-REFERENCE TO RELATED APPLICATION(S)

This application claims the benefit under 35 U.S.C. § 119(a) of Korean Patent Application No. 10-2025-0052393, filed on Apr. 22, 2025, in the Korean Intellectual Property Office, the entire disclosure of which is incorporated herein by reference for all purposes.

### BACKGROUND

### 1. Field

The following description relates to energy harvesting and switching technology.

### 2. Description of Related Art

With advances in science and technology, multifunctional portable electronic devices, such as fitness and healthcare monitoring devices, remote controllers and switching devices, handheld robotic controllers, are frequently being used in fields such as home/building automation, industrial process controls, in defense systems and in daily life. Likewise, wireless sensor networks (WSNs) and the Internet of Things (IoT) are also rapidly developing, and dependence on various sensors is increasing. These portable electronic devices, sensors and switches require power sources in a compact, lightweight, mobile environment, and demand durable operation even in harsh conditions.

Replaceable and rechargeable electrochemical batteries are suitable for supplying power to these devices. However, such batteries have a limited lifespan require periodic recharging or replacement and may also cause environmental pollution due to disposal complexity. In order to replace such batteries, energy harvesting technology for converting mechanical energy into electrical energy is being researched.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

According to an embodiment, there is proposed energy harvester-based switch that combines a magnetic induction method with a switching mechanism to efficiently harvest finger kinetic energy and enable switching using the harvested energy.

According to an embodiment, an energy harvester-based switch, which operates by harvesting energy without a battery or external power supply, includes a coil in which a voltage is induced by electromagnetic induction, a magnetic core magnetically coupled to the coil and having a magnetic core cross-section, and a magnet magnetically coupled to the magnetic core, slidable along the magnetic core cross-section by an external force and configured to induce a voltage across the coil via electromagnetic induction with the magnetic core cross section through a sliding movement without requiring a physical closed circuit loop for flux flow.

The energy harvester-based switch may be opened or closed according to a position of the magnet resulting from the sliding movement of the magnet.

The coil may be wound around the entire magnetic core.

The coil may be arranged in a length direction of the magnetic core, and the magnet may be separately arranged above the magnetic core in a width direction of the magnetic core.

The energy harvester-based switch may further include a housing including an inner space for accommodating components and configured to guide movement of the magnet in the inner space, wherein the coil may surround the magnetic core along an inner curved surface of the housing.

The magnetic core may form a bistable state in which the magnetic core cross-section has two stable states, such that the magnet is maintained at a corresponding stable position.

The magnet may maximize magnetic induction while sliding along the magnetic core cross-section.

The energy harvester-based switch may further include a rod arranged above the magnet, assisting movement of the magnet through magnetic attraction with the magnet, and repeatedly contacting and separating from the magnet, and an actuator arranged to apply an external force to the rod so as to move the rod.

The rod may adjust polarity relative to the magnetic core cross-section during sliding operation of the magnet through a contact scheme based on magnetic attraction with the magnet.

The actuator may set an initial position of the rod and control the rod to slide by an electromagnetic force.

The energy harvester-based switch may further include a separation layer arranged between the magnetic core and the magnet, formed of a non-magnetic material, and configured to adjust the magnitude of a magnetic force between the magnetic core and the magnet.

The energy harvester-based switch may further include a wireless transmission module configured to be operated by the voltage induced in the coil through the sliding movement of the magnet and to wirelessly transmit a switching control signal to a receiver.

Other features and aspects will be apparent from the following detailed description, the drawings, and the claims.

### BRIEF DESCRIPTION OF THE DRAWINGS

FIG. 1 is a view illustrating a configuration of an energy harvester-based switch according to an embodiment of the present invention.

FIG. 2 is a view illustrating a sliding operation mechanism of an energy harvester-based switch according to an embodiment of the present invention.

FIG. 3 is a diagram illustrating magnetic flux density analysis according to an embodiment of the present invention.

FIG. 4A is a view illustrating a separation layer for force adjustment according to an embodiment of the present invention.

FIG. 4B is a graph showing the calculated magnetic attraction force between the magnet and the core cross section by varying the separation air gap for geometry optimization of the switch.

FIG. 4C is a graph showing the measured actuation force by varying the polyimide (PI) separator thickness.

FIG. 5 is a view illustrating a rod that automatically adjusts magnetic polarity through micro-scale rotation (θ) when a magnetic core cross-section comes into contact with a magnet according to an embodiment of the present invention.

FIG. 6 is a graph illustrating an opening/closing (ON/OFF) operation of an energy harvester-based switch according to an embodiment of the present invention.

FIG. 7 is a diagram illustrating a configuration of an energy harvester-based switch including a wireless transmission module according to an embodiment of the present invention.

FIG. 8A is a view illustrating magnets according to various embodiments of the present invention.

FIG. 8B is a view illustrating the operating modes and the orientations of the energy harvester switch and the voltage waveforms during single sliding ON-OFF cycle.

FIG. 8C is a view illustrating an extended rotational energy harvesting switch architecture that implies to the similar core, coil and separator design by implementing the diametrically polarized disc magnet.

FIG. 8D is a graph illustrating the switching voltage induced during the 180-degree rotation of the magnet over the separation layer overlapping the core cross section, wherein the voltage may be induced due to magnetic polarity reversal.

FIG. 8E is a view illustrating a linear push architecture of the diametrical polarized ring magnet arranged such that it makes magnetic contact through its width with the core cross section via separation layer for switching voltage signal generation.

FIG. 8F is a graph illustrating the switching voltage waveform that may be generated during linear push and pull operations of the architecture in FIG. 8E.

FIG. 8G is a view illustrating the magnet design and choice variations to accomplish the switching voltage generations through sliding motion, in plane rotational motion and/or linear push in plane or vertical configuration.

FIG. 9 is a view illustrating magnetic cores according to various embodiments of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The advantages and features of the present invention and the manner of achieving the advantages and features will become apparent with reference to embodiments described in detail below together with the accompanying drawings. However, the present invention may be implemented in many different forms and should not be construed as being limited to the embodiments set forth herein, and the embodiments are provided such that this disclosure will be thorough and complete and will fully convey the scope of the present invention to those skilled in the art, and the present invention is defined only by the scope of the appended claims. The same reference numerals refer to the same components throughout this disclosure.

In the following description of the embodiments of the present invention, if a detailed description of related known functions or configurations is determined to unnecessarily obscure the gist of the present invention, the detailed description thereof will be omitted herein. The terms described below are defined in consideration of the functions in the embodiments of the present invention, and these terms may be varied according to the intent or custom of a user or an operator. Therefore, the definitions of the terms used herein should follow contexts disclosed herein.

In addition, each block or each step may represent a portion of a module, segment, or code including one or more executable instructions for executing one or more specified logical functions, and in some alternative embodiments, it should be noted that functions described in the blocks or the steps may occur in a different order. For example, two successive blocks or steps may actually be performed substantially concurrently, and it is also possible that the blocks or steps are performed in the reverse order of their corresponding functions, as needed.

Hereinafter, embodiments of the present invention will be described in detail with reference to the accompanying drawings. However, the present invention may be realized in various forms, and the scope of the present invention is not limited to such embodiments. The embodiments of the present invention are provided to aid those skilled in the art in the explanation and the understanding of the present invention.

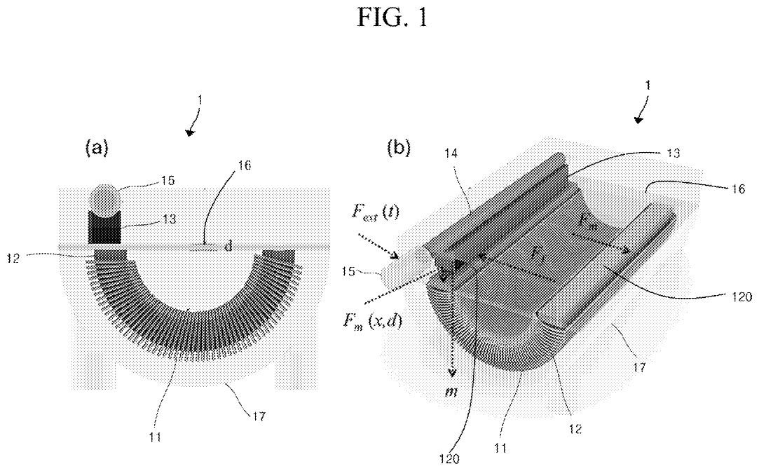

FIG. 1 is a view illustrating a configuration of an energy harvester-based switch according to an embodiment of the present invention.

(a) of FIG. 1 is a plan view of an energy harvester-based switch, and (b) of FIG. 1 is a perspective view thereof.

Referring to FIG. 1, an energy harvester-based switch 1 is a wireless self-powered switch. A wireless switch is an essential component of modern technology, enabling the control of a device or IoT components without physical wiring. Such switching technology may be used in various fields such as building lighting automation in smart homes, industrial control and machine monitoring, wearable devices, and remote monitoring and control of medical devices. The functionality of the wireless switch may be implemented through a combination of hardware, communication protocols, and energy solutions. In particular, the energy harvester-based switch 1 can continuously operate without a battery or an energy storage device.

Generally, various kinetic energy conversion technologies, such as piezoelectric, triboelectric, and electromagnetic schemes, are applied to wireless switching. However, these methods have a limitation in that the energy generated at low frequencies is insufficient to directly operate a wireless protocol, and thus energy storage is required. In addition, although such methods may be useful for simply generating a self-powered signal, an additional power source is required to achieve practical self-sustainability at a system level.

In this context, the energy harvester-based switch 1 efficiently converts kinetic energy generated during operation of a switching element into electrical energy, so that a wireless transmission module may be driven by only a single switching operation. Accordingly, it is possible to provide a self-sustaining wireless switching platform that operates without a separate power source or energy storage device.

To this end, the energy harvester-based switch 1 converts an ultra-low-frequency motion of a sliding-type bistable switch into electrical energy, thereby enabling wireless switching and control of various IoT components. The energy harvester-based switch 1 generates successive positive and negative voltage pulses during a sliding operation, and even a single voltage pulse may operate the wireless transmission module to transmit a switching control signal to a receiver. Accordingly, building lighting and various IoT components may be controlled without a battery.

The energy harvester-based switch 1 may operate independently through only a sliding motion of a human finger. Unlike a conventional electromagnetic generator having a simple magnet-coil configuration, the energy harvester-based switch 1 includes a coil 11 wound around and arranged along a magnetic core (ferrite core or any ferromagnetic split cores) 12, and a magnet 13 having polarity. Rather than relying on simple movement of the magnet, the energy harvester-based switch 1 enables smooth sliding-mode operation by realizing a change in magnetic-field polarity along a pair of magnetic core cross-sections 120, thereby generating high energy output and effectively generating a switching signal.

The energy harvester-based switch 1 harvests energy through voltage pulses generated during sliding by using the coil 11 wound around the magnetic core 12 and the magnetized magnet 13.

As a key feature of the energy harvester-based switch 1, the pair of magnetic core cross-sections 120 form a bistable state, which represents two stable states, such that the magnet 13 may be maintained at a corresponding stable position through magnetic attraction, and thus no additional spring element for mechanical switching is required.

As another feature, the energy harvester-based switch 1 may efficiently perform polarity adjustment with respect to the pair of magnetic core cross-sections 120 during sliding operation of the magnet 13 through a contact scheme based on magnetic attraction between a magnetic rod 14 and the magnet 13.

The energy harvester-based switch 1 may generate a sufficient voltage through only a single low-frequency, low-force sliding operation, so that the wireless transmission module and the circuit may be operated and a control signal may be transmitted to a receiver. This process is performed within a short switching time.

The energy harvester-based switch 1 implements remote control and monitoring without requiring a battery or power source by using a sliding motion of a finger, thereby enabling miniaturized, self-sustaining wireless switching for industrial and home automation.

Hereinafter, the above-described configuration will be described in more detail with reference to FIG. 1.

Referring to FIG. 1, the energy harvester-based switch 1 includes the coil 11, the magnetic core 12, the magnet 13, the rod 14, an actuator 15, a separation layer 16, and a housing 17.

The housing 17 includes, therein, an inner space for accommodating components including the coil 11, the magnetic core 12, the magnet 13, and the rod 14. In this case, the coil 11 and the magnetic core 12 are separated from the magnet 13 and the rod 14 with the separation layer 16 located therebetween. The coil 11 and the magnetic core 12 may be positioned below the separation layer 16, and the magnet 13 and the rod 14 may be positioned above the separation layer 16. The housing 17 guides sliding movement of the magnet 13 in the inner space.

The housing 17 may be printed using a 3D printing material such as PLA, ABS, PET, PVC, TPU, or WPU. The housing 17 may be manufactured by micromachining or manual fabrication using metal, wood, or thermoplastic plastic. The shape of the housing 17 may be determined according to the shapes of the coil 11 and the magnetic core 12. For example, when the magnetic core 12 is C-shaped, the housing 17 may have a semi-cylindrical shape. The housing 17 may include an upper cover or a lower space for circuit placement.

A voltage is induced in the coil 11 by electromagnetic induction. The coil 11 may be wound around the magnetic core 12 in a length direction of the magnetic core 12. The coil 11 may surround the magnetic core 12 along an inner curved surface of the housing 17.

The coil 11 may be wound around the entire magnetic core 12. As the number of turns of the coil 11 around the magnetic core 12 increases, the electromagnetic induction increases.

The magnetic core 12 is electromagnetically coupled to the coil 11 and has the magnetic core cross-sections 120. As shown in FIG. 1, the magnetic core 12 may be C-shaped. The magnetic core 12 is formed of a material having high magnetic permeability and may, as needed, be formed of a high-permeability material such as ferrite, silicon steel, an amorphous material, a powdered material, a bulk metal, a nickel alloy, or a cobalt alloy.

The magnetic core 12 may have a C-shaped cylindrical form. The magnetic core 12 provides a path for magnetic flux, and the coil 11 is wound in the length direction of the magnetic core 12 such that a voltage is induced by bistable movement of the magnet 13.

The magnet 13 is arranged above the magnetic core cross-section 120, and the rod 14 is arranged above the magnet 13. The actuator 15 is arranged to apply an external force to the rod 14. A sliding space is provided between the magnetic core cross-sections 120. When an external force is applied to the rod 14 by the actuator 15, the rod 14 performs microscale sliding motion for dynamic polarity readjustment, and the magnet 13 also performs a sliding motion together with the rod 14.

The magnet 13 is arranged above and aligned with the magnetic core 12, is slidable along the pair of magnetic core cross-sections 120 by an external force. Through the sliding movement, the magnet 13 induces a voltage in the coil 11 via electromagnetic induction resulting from interaction with the magnetic core 12 at two core cross-sections For example, the magnet 13 may induce a transient voltage pulse across the coil via electromagnetic induction with the magnet sliding across the magnetic core cross-section through external actuation, and the present invention does not particularly require a physically closed magnetic path considering the sliding magnet and the core for flux guiding along the core.

The magnet 13 is separately arranged above the magnetic core 12 in a width direction of the magnetic core 12 and is in a magnetized state. The magnet 13 may slide over the magnetic core cross-section 120. The magnet 13 may be an NdFeB magnet, an Alnico magnet, a samarium-cobalt magnet, a ferrite magnet, a neodymium magnet, or a temporary magnet.

As shown in FIG. 1, the magnetic core 12 may be fixed, and the magnet 13 may slide over the pair of magnetic core cross-sections 120. In another example, the magnet 13 may be fixed and the magnetic core 12 may slide within a plane.

The energy harvester-based switch 1 uses a method of converting energy by utilizing the sliding operation of the magnet 13 and reversal of magnetic flux. The energy harvester-based switch 1 combines a simple structure with high-efficiency energy conversion technology to realize a battery-free, self-powered system.

The rod 14 is arranged above the magnet 13, assists movement of the magnet 13 through magnetic attraction with the magnet 13, and offers microscale rotation or sliding movements with respect to the magnet 13 to allow dynamic polarity adjustment with the core through snap through transition. The rod 14 may be formed of a soft magnetic material such as metal alloys, ferromagnetic or ferrite materials. The energy harvester-based switch 1 may adjust polarity based on the magnetic attraction between the rod 14 and the magnet 13. Accordingly, efficient polarity adjustment is possible during the sliding operation, and energy loss generated during operation of the device 1 may be minimized.

The actuator 15 is arranged to apply an external force to the rod 14 so as to move the magnet with the assistance of rod 14. The external force may be a force generated by a sliding motion of a user's finger. The actuator 15 may have a shape protruding from the housing 17 so as to be easily gripped by a user's fingers.

The sliding motion of the user's finger applied to the rod 14 through the actuator 15 moves the magnet 13 provided below the rod 14, and in this process, the magnet 13 traverses the magnetic core cross-sections 120. Such a sliding motion induces a change in magnetic flux, and the change in magnetic flux induces a voltage in the coil 11. In this case, the induced voltage may be used to drive the wireless transmission module such as a radio frequency (RF) transmitter or a Bluetooth low energy (BLE) module. Accordingly, the device 1 may be stably operated without an external power source or a battery.

The separation layer 16 is provided in the form of a membrane between the magnetic core 12 and the magnet 13, and adjusts the magnitude of the magnetic force between the magnetic core 12 and the magnet 13. The separation layer 16 minimizes sliding friction, reduces a force required for operation of the device 1, and prevents direct contact between the magnetic core 12 and the magnet 13, thereby improving durability and minimizing mechanical fatigue. The separation layer 16 is non-magnetic and may be in the form of a film.

The energy harvester-based switch 1 is a wireless switch that is advanced beyond a simple magnet-coil configuration of a conventional electromagnetic generator by utilizing a magnetic-flux polarity conversion technique without requiring a physical closed loop path along with the core based on a sliding operation, without requiring an external power source or a battery. For example, the energy harvester-based switch 1 allows a sliding-mode operation to be flexibly performed by switching magnetic-flux polarity at the magnetic core cross-sections 120, thereby enabling high energy output and signal switching.

In particular, the energy harvester-based switch 1 has a bistable state in which the magnetic core cross-sections 120 themselves provide two stable states and do not require a closed physical loop connection for flux flow. Accordingly, since the magnet 13 may be fixed at a specific position during operation, a separate spring element for mechanical return is not required. Such a design simplifies the structure of the device, reduces mechanical complexity, and at the same time improves durability.

The separation layer 16 provided between the magnetic core 12 and the magnet 13 reduces sliding friction, minimizes an actuation force, and prevents direct contact between the magnetic core 12 and the magnet 13, thereby improving durability of the device and minimizing mechanical fatigue. Such a design ensures high reliability and a long lifespan even under repeated operation.

The energy harvester-based switch 1 may generate a sufficient voltage to drive the wireless transmission module and circuit even with only a low-frequency, low-force sliding operating force, and may transmit a signal within a short switching time to control lighting, IoT devices, and the like. Accordingly, the energy harvester-based switch 1 provides practical value in various applications, such as smart homes, industrial automation, and medical devices, through reduction in maintenance cost, improvement in energy efficiency, and structural simplification.

The energy harvester-based switch 1 may solve actuation-force issues occurring in a conventional vertical push method that often rely on the closed magnetic path or physical closed loop for energy generation, and this issue may be solved through an energy conversion scheme in a sliding mode. The sliding operation of the energy harvester-based switch 1 may generate sufficient energy even with a low actuation force, and thus user fatigue may be minimized.

Referring to (b) of FIG. 1, in the energy harvester-based switch 1, the rod 14 is moved by an external force Fₑₓₜ(t). When the external force Fₑₓₜ(t) is applied to the rod 14 by the actuator 15, a force Fₘ(x, d) generated by electromagnetic induction and forces F_{f} and Fₘ acting between the rod 14 and the magnetic core 12 affect movement of the magnet 13.

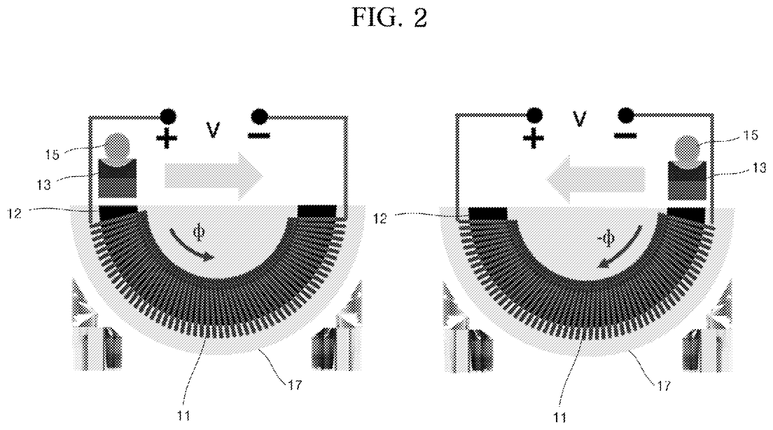

FIG. 2 is a view illustrating a sliding operation mechanism of the energy harvester-based switch according to an embodiment of the present invention.

Referring to FIGS. 1 and 2, the energy harvester-based switch 1 implements a magnetically stable state through magnetic attraction between the magnetic core 12 and the magnet 13, and generates positive and negative voltage pulses according to whether the magnet 13 moves over the magnetic core cross-sections.

When the rod 14 is moved by a user's finger from the outside through the actuator 15, the energy harvester-based switch 1 induces an alternating-current voltage in the coil 11 based on the principle of magnetic flux (Φ) reversal. When the changing magnetic flux through the coil 11 is reversed, this change induces a voltage. This is referred to as the law of electromagnetic induction, according to which a change in magnetic flux causes an electrical effect. As the magnetic flux changes, a current flows, and when the direction of the magnetic flux is reversed, the direction of the induced current is also reversed.

The operating principle of the energy harvester-based switch 1 is based on magnetic flux reversal during snap through dynamics at magnet core and soft metal rod interface. As the magnet 13 slides over the magnetic core cross-sections, the magnetic flux is repeatedly reversed, and accordingly an alternating-current voltage is induced in the coil 11. The magnet 13 maintains a bistable state during sliding, thereby ensuring operational stability, and generates a high-output voltage even through a single sliding operation. Such a voltage is sufficient to drive the wireless transmission module such as a wireless RF transmitter or a BLE device, thereby making it possible to transmit a real-time switching control signal in an IoT sensor network or a building automation system.

The energy harvester-based switch 1 may be considered opened or closed (on/off) condition based on the polarity of the voltage pulse which is according to the position of the magnet 13 resulting from the sliding movement of the magnet 13.

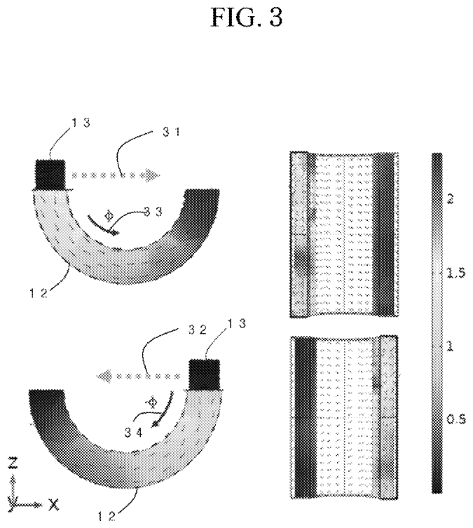

FIG. 3 is a diagram illustrating magnetic flux density analysis according to an embodiment of the present invention.

Referring to FIGS. 1 and 3, through COMSOL simulation, it is possible to analyze a density of the magnetic flux Φ between the magnetic core 12 and the magnet 13 when the magnet 13 slides over the magnetic core 12.

The left diagram (in FIG. 3) illustrates a distribution of magnetic flux Φ according to movement of the magnet 13, and the right diagram illustrates a cross-sectional analysis of a density of the magnetic flux Φ.

In the left diagram, changes 33 and 34 in the magnetic flux Φ according to movements 31 and 32 of the magnet 13 may be identified through arrows. It may be confirmed how the density and the direction of the magnetic flux Φ change according to the movement direction (leftward or rightward) of the magnet 13.

In the right diagram, a color bar represents an intensity of the magnetic flux Φ density, where colors are displayed differently for a strong magnetic field of 2 tesla T or greater and a relatively weak magnetic field.

In FIG. 3, regions with high and low magnetic flux Φ density are represented by colors, and a reversal phenomenon of the magnetic flux Φ during movement may be visually confirmed.

When the magnet 13 moves, the magnetic flux Φ of the magnetic core 12 is reversed, thereby verifying the principle by which an induced voltage is generated.

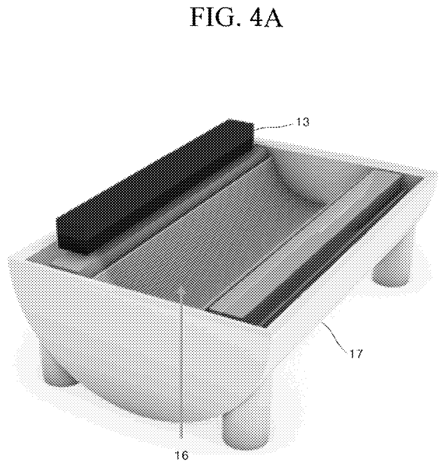

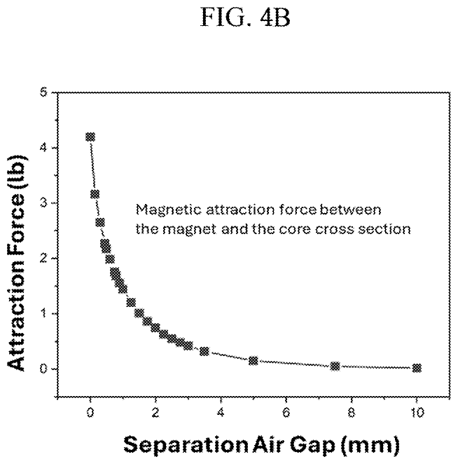

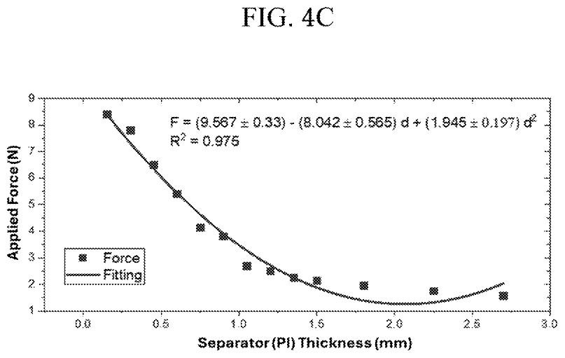

FIG. 4A is a view illustrating a separation layer for force adjustment according to an embodiment of the present invention.

Referring to FIGS. 1 and 4A, the separation layer 16 allows sliding movement of the magnet 13 to be smoothly performed. The separation layer 16 serves to reduce energy loss that may occur during the sliding of the magnet 13 and to improve the durability of the device.

The separation layer 16 helps adjust an actuation force (FIG. 4B and FIG. 4C) of the device and an output voltage of the device to meet power requirements of a wireless transmission module and a hardware component module.

The separation layer 16 may be made of various materials including polyimide, thermoplastic plastic, adhesive tape, wood film, a glass sheet, a 3D printing material, and a non-magnetic metal film.

The shape of the separation layer 16 is not limited to a rectangular shape and may be formed in another polygonal shape.

The housing 17 may be manufactured by 3D printing or precision machining technology. This allows for a customized design tailored to user requirements, enabling the utilization of the housing 17 in various application fields such as smart homes, industrial automation, medical devices, and wearable technology.

The housing 17 serves to guide the movement path of the magnet 13 while maintaining lightweight properties, and may be designed to include, if necessary, a space for circuit placement.

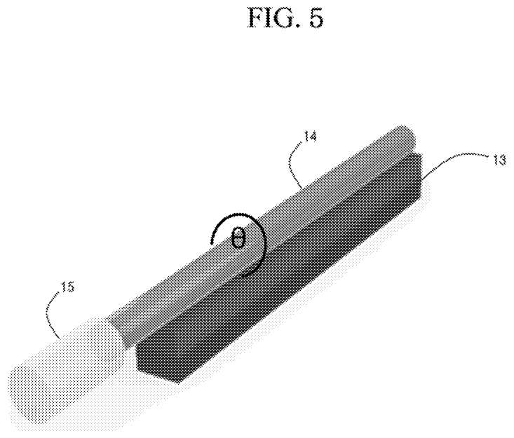

FIG. 5 is a view illustrating a rod that automatically adjusts magnetic polarity when a magnetic core cross-section comes into contact with a magnet according to an embodiment of the present invention.

Referring to FIGS. 1 and 5, the rod 14 may be formed of a soft magnetic material and, when the magnet 13 overlaps the magnetic core cross-section during a sliding operation, may self-adjust magnetic polarity and improve flux coupling, thereby increasing output efficiency.

The rod 14 may be formed of a soft magnetic material, and may optimize flux coupling by automatically adjusting magnetic polarity. This significantly improves energy conversion efficiency and at the same time prevents mechanical fatigue due to repeated operation. In particular, this design ensures stable long-term performance and solves a problem of insufficient durability pointed out in the related art.

The material of the rod 14 is not limited to a soft magnetic material, and may be a 3D printing polymer, a thermoplastic plastic, another metal, or a magnet itself. The rod 14 may be cylindrical.

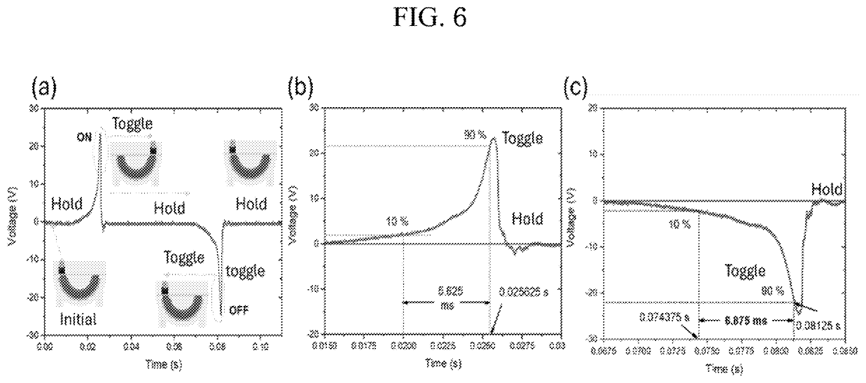

FIG. 6 is a graph illustrating an opening/closing (ON/OFF) operation of the energy harvester-based switch according to an embodiment of the present invention.

Referring to FIGS. 1 and 6, a process in which the energy harvester-based switch 1 is opened or closed according to movement of the magnet 13 is described step by step, and whether the circuit of the energy harvester-based switch 1 is opened or closed may be determined according to whether the magnet 13 is in contact with the rod 14.

(a) of FIG. 6 is a graph analyzing a change in voltage of the energy harvester-based switch over time.

Referring to (a) of FIG. 6, the energy harvester-based switch 1 starts from an initial state and repeatedly enters a toggle state and a hold state. For example, operation of the energy harvester-based switch 1 starts in the initial state and changes to the toggle state. At this time, the voltage changes sharply due to electromagnetic induction. This corresponds to an “ON” state.

After the toggle state, the voltage becomes stabilized, and the hold state is maintained for a certain period of time.

Subsequently, as the energy harvester-based switch 1 again changes to the toggle state, the voltage changes. This corresponds to an “OFF” state. The hold state is maintained unless it is toggled to another state by external force.

The “ON” state and the “OFF” state of the energy harvester-based switch 1 are distinguished by a change in voltage, and a sharp voltage change occurs at a specific moment. A point in time at which the voltage changes sharply occurs depending on whether the rod 14 and the magnet 13 are in contact with each other during snap through transitions between the core cross sections.

(b) of FIG. 6 is a graph analyzing in detail a voltage change between the toggle state and the hold state.

Referring to (b) of FIG. 6, a response time of 5.625 ms for a 10% to 90% voltage increase in the initial state is shown. A process in which the voltage is stabilized back to the hold state after the toggle operation is observed.

(c) of FIG. 6 is a graph showing a toggle operation in an opposite direction.

Referring to (c) of FIG. 6, a response time of 6.875 ms for a 10% to 90% voltage drop is measured. The energy harvester-based switch 1 returns to a stable hold state after a specific period of time.

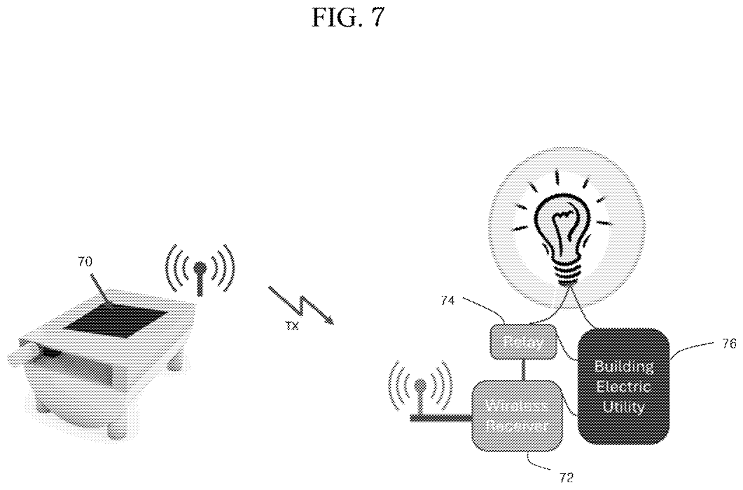

FIG. 7 is a diagram illustrating a configuration of an energy harvester-based switch including a wireless transmission module according to an embodiment of the present invention.

Referring to FIGS. 1 and 7, the energy harvester-based switch 1 may further include a wireless transmission module 70.

The wireless transmission module 70 is operated by the voltage induced in the coil 11 through sliding movement of the magnet 13, and transmits a switching control signal to a wireless receiver 72. The wireless transmission module 70 may be, for example, an RF transmitter or a BLE device.

The energy harvester-based switch 1 may generate a very high electromagnetic induction voltage pulse through a single switching operation to operate the wireless transmission module 70, and may transmit the switching control signal to the wireless receiver 72 through the wireless transmission module 70.

The receiver 72 may deliver the switching control signal to an IoT component or to a building electric utility 76 for building automation. In this case, the receiver 72 may deliver the switching control signal through a relay 74. FIG. 7 illustrates an example in which building lighting is operated by the switching control signal of the energy harvester-based switch 1.

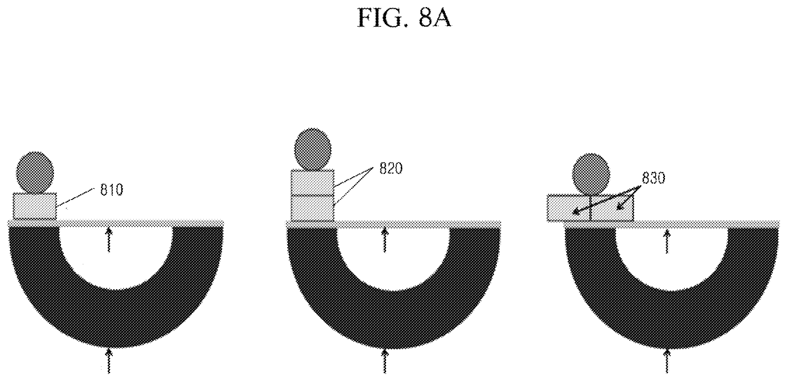

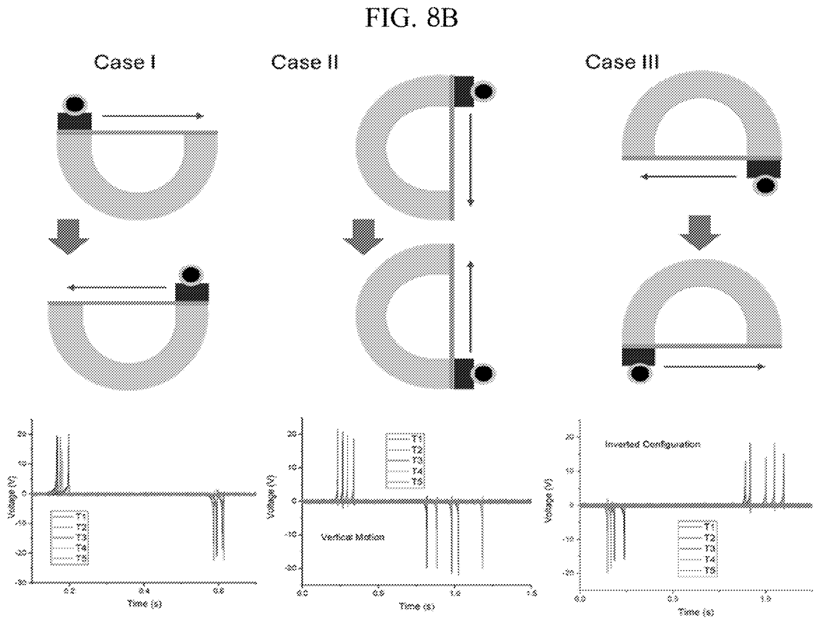

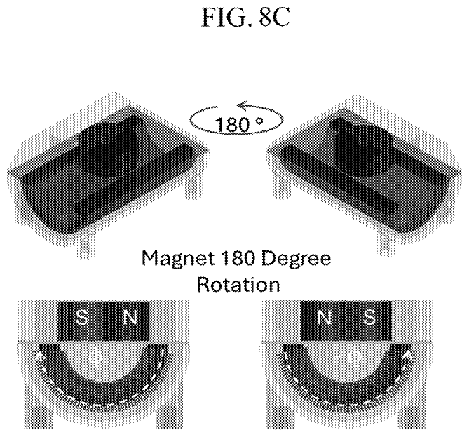

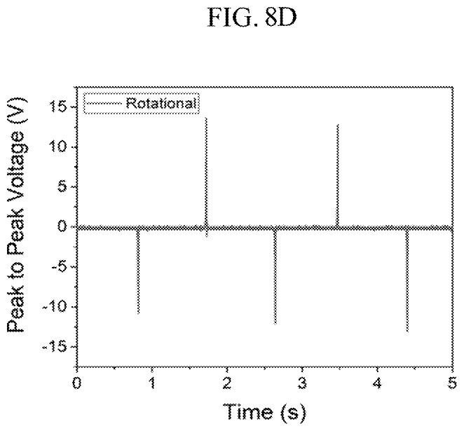

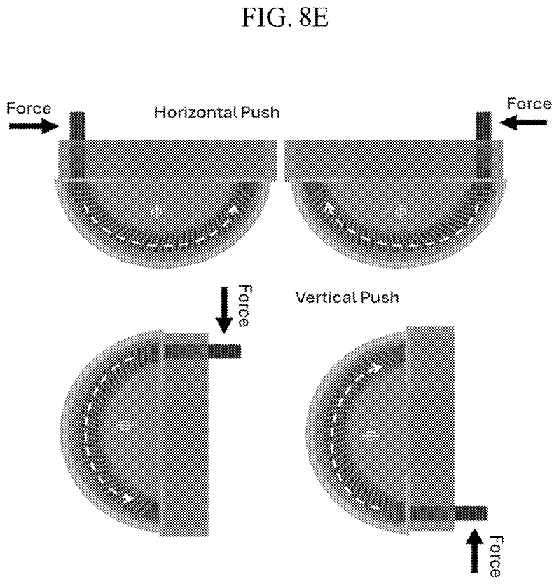

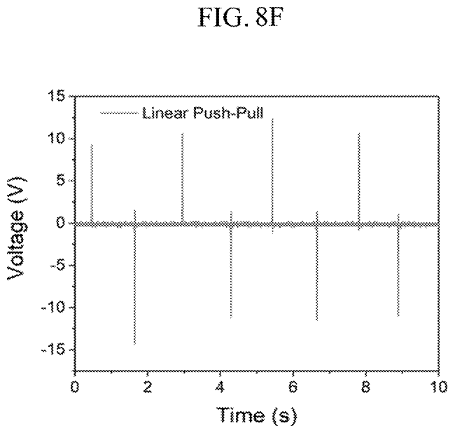

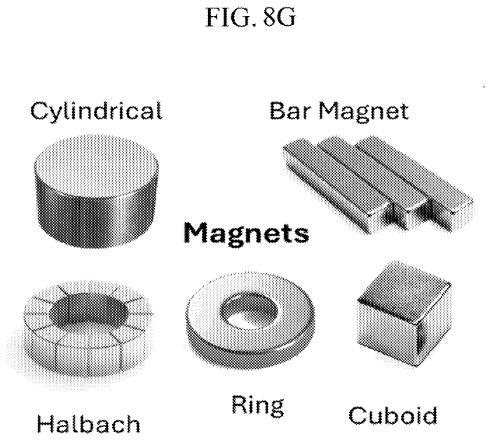

FIG. 8A is a view illustrating magnets according to various embodiments of the present invention.

Referring to FIGS. 1 and 8A, the magnet of the energy harvester-based switch may be a single magnet 810, stacked two magnets 820, or stacked side magnets 830.

The single magnet 810 is an arrangement in which one magnet is provided.

The stacked two magnets 820 are an arrangement in which two magnets are vertically stacked.

The stacked side magnets 830 are an arrangement in which magnets are arranged side by side. Other than that, the magnet shapes may not be limited to the rectangular polar magnets, and can be in disc shaped diametrically polarized magnets cuboidal magnets or several magnets arranged in Halbach array configurations (FIG. 8D)

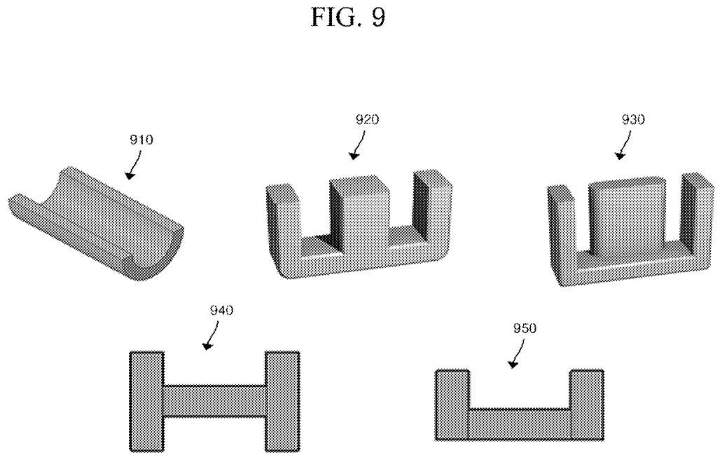

FIG. 9 is a view illustrating magnetic cores according to various embodiments of the present invention.

Referring to FIGS. 1 and 9, the magnetic core structure may be implemented as a split C-type magnetic core (C-core) 910, an E-type magnetic core (E-core) 920, an EFD-type magnetic core 930, a mirror U-type magnetic core (mirror U-core) 940, a U-type magnetic core (U-core) 950, a rectangular magnetic core, or an inverted U-type magnetic core.

The present invention enables efficient energy use by using harvested energy without a battery or an external power source for power supply.

Since the present invention does not require battery replacement or power supply, maintenance costs are reduced in the long term, thereby ensuring sustainability.

According to the present invention, since a switch can be wirelessly connected to a control system without wires, installation is simple and flexible installation is possible.

According to the present invention, by utilizing energy generated from natural motion, an environmentally friendly system can be realized.

The present invention provides high conversion efficiency by applying magnetic induction-based energy harvesting technology.

The present invention provides a wireless switch without a battery or power source, the wireless switch having high-efficiency energy conversion, durability, and structural simplicity. Accordingly, maintenance costs are reduced, applicability in various environments is expanded, and a stable and sustainable energy solution suitable for a smart environment is implemented.

The present invention provides a low actuation force. That is, a force required to operate the device is small. The device can be easily operated only by movement of a user's finger.

The present invention has a simple structure and may be used in various environments. For example, the present invention may be applied to smart homes, industrial equipment, wearable devices, the IoT, and the like, in which harvested energy enables operation of wireless switches or sensors without batteries.

Heretofore, the present invention has been described by focusing on the exemplary embodiments. It can be understood by those skilled in the art to which the present invention pertains that the present invention can be implemented in modified forms without departing from the essential feature of the present invention. Therefore, the disclosed embodiments should be considered as illustrative rather than determinative. The scope of the present invention is defined by the appended claims rather than by the foregoing description, and all differences within the scope of equivalents thereof should be construed as being included in the present invention.

What is claimed is:

1. An energy harvester-based switch, which operates by harvesting energy without a battery or external power supply, comprising:
a coil in which a voltage is induced by electromagnetic induction;
a magnetic core magnetically coupled to the coil and having a magnetic core cross-section; and
a magnet magnetically coupled to the magnetic core, slidable along the magnetic core cross-section by an external force and configured to induce a voltage in the coil via electromagnetic induction with the magnetic core through a sliding movement without requiring a physical closed circuit loop for flux flow.

2. The energy harvester-based switch of claim 1, wherein the energy harvester-based switch is opened or closed according to a position of the magnet resulting from the sliding movement of the magnet.

3. The energy harvester-based switch of claim 1, wherein the coil is wound around an entire magnetic core.

4. The energy harvester-based switch of claim 1, wherein the coil is arranged in a length direction of the magnetic core, and
the magnet is separately arranged above the magnetic core in a width direction of the magnetic core.

5. The energy harvester-based switch of claim 1, further comprising:
a housing including an inner space for accommodating components and configured to guide movement of the magnet in the inner space,
wherein the coil surrounds the magnetic core along an inner curved surface of the housing.

6. The energy harvester-based switch of claim 1, wherein the magnetic core forms a bistable state in which the magnetic core cross-section has two stable states, such that the magnet is maintained at a corresponding stable position.

7. The energy harvester-based switch of claim 1, wherein the magnet maximizes magnetic induction while sliding along the magnetic core cross-section.

8. The energy harvester-based switch of claim 1, further comprising:
a rod arranged above the magnet, assisting movement of the magnet through magnetic attraction with the magnet, and repeatedly contacting and separating from the magnet; and
an actuator arranged to apply an external force to the rod so as to move the rod.

9. The energy harvester-based switch of claim 8, wherein the rod adjusts polarity relative to the magnetic core cross-section during sliding operation of the magnet through a contact scheme based on magnetic attraction with the magnet.

10. The energy harvester-based switch of claim 8, wherein the actuator sets an initial position of the rod and controls the rod to slide by an electromagnetic force.

11. The energy harvester-based switch of claim 1, further comprising a separation layer arranged between the magnetic core and the magnet, formed of a non-magnetic material, and configured to adjust a magnitude of a magnetic force between the magnetic core and the magnet.

12. The energy harvester-based switch of claim 1, further comprising a wireless transmission module configured to be operated by the voltage induced in the coil through the sliding movement of the magnet and to wirelessly transmit a switching control signal to a receiver.
